(19) United States
(12) Patent Application Publication
(10) Pub. No.: US 2026/0057487 A1
(43) Pub. Date: Feb. 26, 2026

(54) UNSUPERVISED ARTIFICIAL INTELLIGENCE EXPOSURE SYNTHESIS AND FUSION FOR TONE MAPPING

(71) Applicant: Samsung Electronics Co., Ltd., Suwon-si (KR)

(72) Inventors: Yongyi Zhao, Pearland, TX (US); Nguyen Thang Long Le, Garland, TX (US); Hamid Rahim Sheikh, Allen, TX (US)

(21) Appl. No.: 18/813,001

(22) Filed: Aug. 22, 2024

(51) Int. Cl. G06T 5/60; G06T 5/50; G06T 5/92

(52) U.S. Cl. CPC G06T 5/60; G06T 5/50; G06T 5/92; G06T 2207/20081; G06T 2207/20084; G06T 2207/20208; G06T 2207/20221

(57) ABSTRACT

A method for tone mapping a high dynamic range (HDR) image to a low dynamic range (LDR) image includes obtaining an HDR image. The method also includes processing the HDR image using an artificial intelligence (AI)-based image tone mapping model, including synthesizing, using the HDR image, a set of LDR images at multiple exposures, providing the set of LDR images to a deep machine learning model included in the AI-based image tone mapping model, and generating, using the deep machine learning model and the set of LDR images, a tone-mapped LDR image. The method also includes performing at least one of storing or displaying the tone-mapped LDR image.

### TECHNICAL FIELD

This disclosure relates generally to machine learning systems. More specifically, this disclosure relates to unsupervised artificial intelligence exposure synthesis and fusion for tone mapping.

### BACKGROUND

Tone mapping can be part of a multi-frame image signal processing pipeline. Tone mapping is used for compressing high dynamic range images into a format that can be visualized on a lower dynamic range system (e.g., a cell phone screen), while preserving image quality and information. However, preserving image quality and information in the lower dynamic range can be particularly difficult with certain scenes, such as scenes which include the presence of neon signs or brightly illuminated light sources. Compressing high dynamic range images of such scenes into a format that can be visualized on a lower dynamic range system often results in image artifacts, such as image artifacts at brightly illuminated light sources of the scene like halo artifacts that can include bright rings around regions that should have been mapped to lower pixel values.

### SUMMARY

This disclosure relates to unsupervised artificial intelligence exposure synthesis and fusion for tone mapping.

In a first embodiment, a method for tone mapping a high dynamic range (HDR) image to a low dynamic range (LDR) image includes obtaining an HDR image. The method also includes processing the HDR image using an artificial intelligence (AI)-based image tone mapping model, including synthesizing, using the HDR image, a set of LDR images at multiple exposures, providing the set of LDR images to a deep machine learning model included in the AI-based image tone mapping model, and generating, using the deep machine learning model and the set of LDR images, a tone-mapped LDR image. The method also includes performing at least one of storing or displaying the tone-mapped LDR image.

In a second embodiment, an electronic device includes at least one processing device. The at least one processing device is configured to obtain an HDR image. The at least one processing device is also configured to process the HDR image using an artificial intelligence (AI)-based image tone mapping model, wherein the at least one processing device is further configured to synthesize, using the HDR image, a set of LDR images at multiple exposures, provide the set of LDR images to a deep machine learning model included in the AI-based image tone mapping model, and generate, using the deep machine learning model and the set of LDR images, a tone-mapped LDR image. The at least one processing device is also configured to perform at least one of storing or displaying the tone-mapped LDR image.

In a third embodiment, a non-transitory machine readable medium includes instructions that when executed cause at least one processor of an electronic device to obtain an HDR image. The non-transitory machine readable medium also includes instructions that when executed cause at the least one processor of the electronic device to process the HDR image using an artificial intelligence (AI)-based image tone mapping model, including synthesize, using the HDR image, a set of LDR images at multiple exposures, provide the set of LDR images to a deep machine learning model included in the AI-based image tone mapping model, and generate, using the deep machine learning model and the set of LDR images, a tone-mapped LDR image. The non-transitory machine readable medium also includes instructions that when executed cause at the least one processor of the electronic device to perform at least one of storing or displaying the tone-mapped LDR image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example artificial intelligence tone mapping architecture in accordance with this disclosure;

FIG. 3 illustrates an example artificial intelligence tone mapping process using a weight generator and image fusion in accordance with this disclosure;

FIG. 4 illustrates an example image fusion operation in accordance with this disclosure;

FIG. 5 illustrates an example artificial intelligence tone mapping process using an LDR image generator in accordance with this disclosure;

FIG. 6 illustrates an example training control method in accordance with this disclosure;

FIG. 7 illustrates another example training control method in accordance with this disclosure;

FIG. 8 illustrates an example method for artificial intelligence tone mapping model training in accordance with this disclosure; and

FIG. 9 illustrates an example method for artificial intelligence tone mapping of an HDR image to an LDR image in accordance with this disclosure.

### DETAILED DESCRIPTION

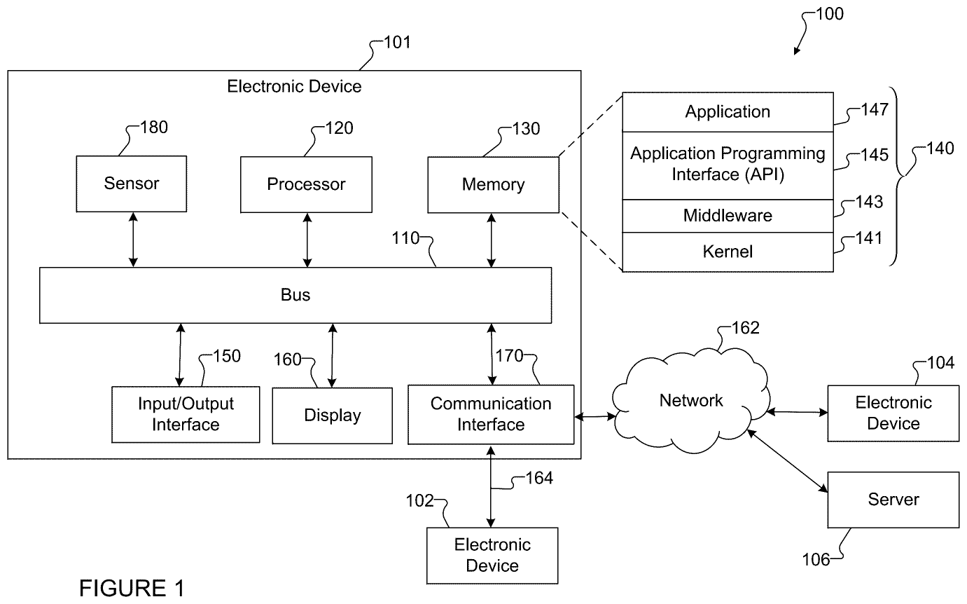

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, tone mapping can be part of a multi-frame image signal processing pipeline. Tone mapping is used for compressing high dynamic range images into a format that can be visualized on a lower dynamic range system (e.g., a cell phone screen), while preserving image quality and information. However, preserving image quality and information in the lower dynamic range can be particularly difficult with certain scenes, such as scenes which include the presence of neon signs or brightly illuminated light sources. Compressing high dynamic range images of such scenes into a format that can be visualized on a lower dynamic range system often results in image artifacts, such as image artifacts at brightly illuminated light sources of the scene like halo artifacts that can include bright rings around regions that should have been mapped to lower pixel values.

Existing tone mapping techniques also may have poor performance with respect to tone target. A tone target relates to perceptually pleasing image expressions (brightness, contrast, color saturation) that is often determined by comparing against alternative images taken by other electronic devices. However, setting a tone target based on a comparison with images taken by other electronic devices cannot account for all scenes and may even negatively impact the visual quality of some scenes. Moreover, existing tone mapping algorithms often require manual tuning to achieve a certain tone target. This tuning can involve changing the color, saturation, and brightness parameters of the algorithm based on metadata for specific scenes. However, since the space of images are large, this process can be very laborious. In addition, because existing tone mapping algorithms rely on limited metadata to adjust parameters, this can result in conflicting results when visually different scenes share the same metadata. For example, the same parameters that increase color saturation and reduce brightness based on a tone target can also lead to halo artifacts in a different scene. This inability to separate complex, high-dimensional, image spaces is a fundamental technical limitation of existing approaches.

The embodiments of this disclosure provide unsupervised artificial intelligence exposure synthesis and fusion for tone mapping. To alleviate the issues with existing approaches, this disclosure proves for artificial intelligence (AI)-based tone mapping that is better suited to the task of tone mapping than existing algorithms and that is able to learn from data to produce the best tone automatically. Although using AI networks to learn to perform tone mapping has been attempted, these previous attempts still experience difficulties in preserving the high dynamic range features in the lower dynamic range image, such as images having poor lighting representation (e.g., over-washed lighting), as well as lighting artifacts such as halo effects around light sources in the scene. Another issue is that some of the prior approaches are trained based on data generated from an existing tone mapping algorithm, which can create redundancy, e.g., the new network would simply learn the existing algorithm.

Embodiments of this disclosure provide an unsupervised AI training framework that uses a high dynamic range (HDR) image and a lower dynamic range (LDR) image as inputs and jointly optimizes image synthesis and image fusion operations using a combination of image quality, structural, and adversarial losses. The image synthesis is optimized with multiple exposure scales and a common gamma, and image quality losses augment the adversarial and structural loss. In various embodiments, an exposure stack including a plurality of LDR images is created from the input HDR image, and the exposure stack is processed by a weight generator network to produce a weight stack. Image fusion is then performed using the exposure stack and the weight stack to create a fused LDR output image. In some embodiments, an image generator network is trained to directly learn the LDR image and is used to process the exposure stack and maps the exposure stack into a tone mapped LDR image.

In some embodiments, a discriminator network can also be used to test the accuracy of the AI tone mapping system by predicting whether an LDR image that is input to the discriminator network is from an LDR dataset or generated by the AI tone mapping system, with the goal being that images generated by the AI tone mapping system become indistinguishable from the LDR images in the LDR dataset.

The AI tone mapping embodiments of this disclosure allow for LDR images to be produced for display on lower dynamic range system (e.g., a smartphone screen), while providing for improved image quality of the LDR images, including improved color expression, reduction or elimination of the presence of image artifacts such as lighting artifacts like halo effects or oversaturation of light sources, improved clarity such as reduction or elimination of hazy or blurry areas of the image, and improved shadow and/or lighting quality (e.g., reducing or eliminating overwashed lighting in scenes).

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may perform one or more functions related to unsupervised artificial intelligence exposure synthesis and fusion for tone mapping.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform unsupervised artificial intelligence exposure synthesis and fusion for tone mapping. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to unsupervised artificial intelligence exposure synthesis and fusion for tone mapping.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

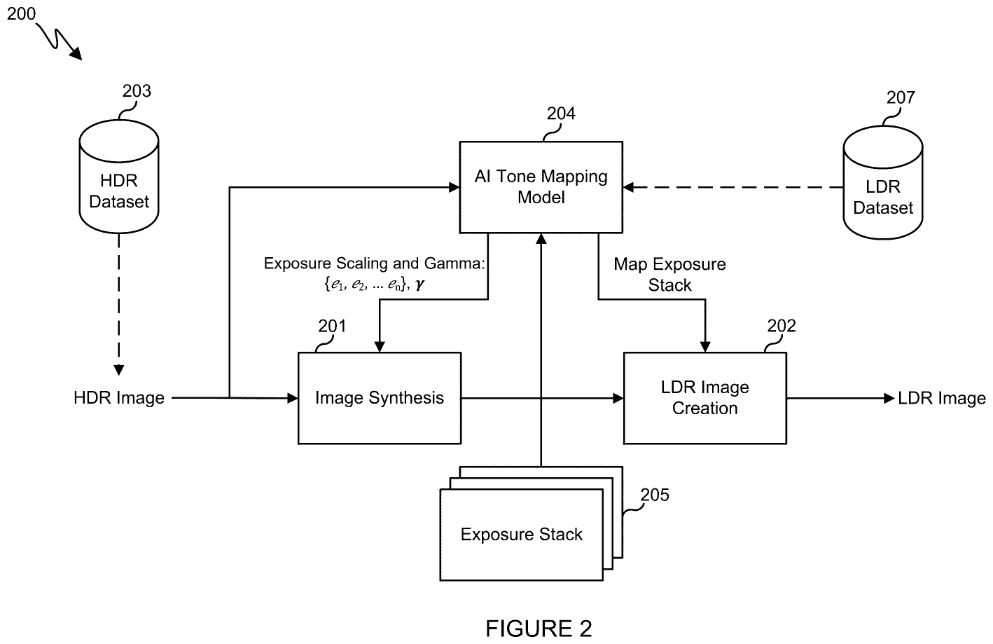

FIG. 2 illustrates an example artificial intelligence (AI) tone mapping architecture 200 in accordance with this disclosure. For ease of explanation, the architecture 200 shown in FIG. 2 may be described as being implemented on or supported by the electronic device 101 in the network configuration 100 of FIG. 1. However, the architecture 200 shown in FIG. 2 could be used with any other suitable device(s) and in any other suitable system(s), such as when the architecture 200 is implemented on or supported by the server 106.

As shown in FIG. 2, the architecture 200 includes an AI tone mapping model 204 that is configured to perform tone mapping of HDR images into LDR images. During inferencing, the AI tone mapping model 204 takes as input an HDR image captured using an HDR image source, like an image capture device of the electronic device 101 such as a camera, an image previously stored in a data storage location, etc., and performs an image synthesis operation 201 to generate an exposure stack 205. The exposure stack 205 is a set of LDR images at various exposure and gamma levels created using set exposure scaling and gamma settings.

The AI tone mapping model 204 uses the exposure stack 205 to perform an LDR image creation operation 202. For example, in some embodiments, the AI tone mapping model 204 can include a deep machine learning model configured to generate a plurality of weight maps, or a weight stack, and to perform a mapping of the exposure stack onto the weight maps, which are then fused via the LDR image creation operation 202 into a fused, and tone mapped, LDR image. As another example, in some embodiments, the AI tone mapping model 204 can include a deep machine learning model configured to perform a mapping of the exposure stack into a tone mapped LDR image, based on the deep machine learning model being trained to directly learn to output a tone mapped LDR image from the exposure stack.

During training, the AI tone mapping model 204 uses as inputs both HDR images from an HDR image dataset 203 and LDR images from an LDR image dataset 207. During the training, the image synthesis operation 201 and the LDR image creation operation 202 can be jointly optimized using a combination of image quality losses, structural losses, and adversarial losses. Image quality losses augment the adversarial and structural losses.

Although FIG. 2 illustrates one example of an AI tone mapping architecture 200, various changes may be made to FIG. 2. For example, various components and functions in FIG. 2 may be combined, further subdivided, replicated, or rearranged according to particular needs. Also, one or more additional components and functions may be included if needed or desired. It will also be understood that the HDR dataset 203 and the LDR dataset 207, which include multiple images for use as training images, may not be used during inferencing. For example, during inferencing, one HDR image would be fed into the pipeline to produce a corresponding LDR image.

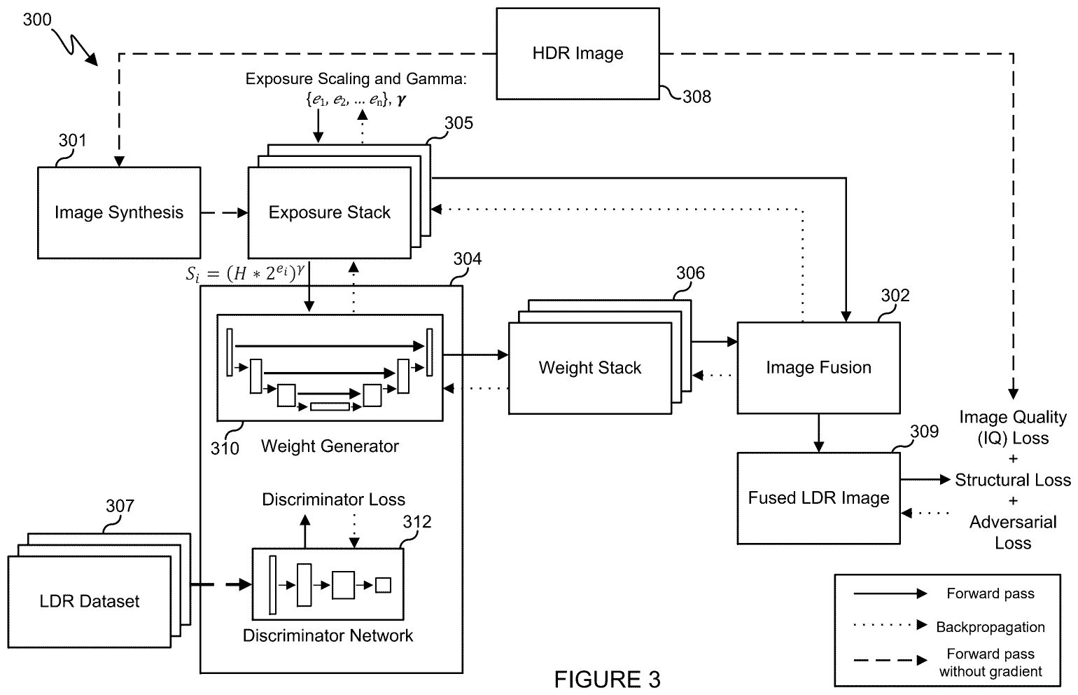

FIG. 3 illustrates an example AI tone mapping process 300 using a weight generator and image fusion in accordance with this disclosure. For ease of explanation, the process 300 shown in FIG. 3 may be described as being implemented on or supported by the electronic device 101 in the network configuration 100 of FIG. 1. However, the process 300 shown in FIG. 3 could be used with any other suitable device(s) and in any other suitable system(s), such as when the process 300 is implemented on or supported by the server 106.

As shown in FIG. 3, the process 300 includes performing an image synthesis operation 301 on an HDR image 308. During training, the HDR image 308 may be retrieved from an HDR dataset, such as the HDR dataset 203. However, during inferencing, the HDR image 308 may be provided as an image taken with an image capture device such as a camera or retrieved from a storage location in which the HDR image 308 was previously stored. The process 300 includes providing the HDR image 308 to an image synthesis operation 301. The image synthesis operation 301 generates an exposure stack 305 (S) based on the HDR image 308 (H) as well as exposure scaling and gamma settings. For example, the operation 301 can take an input image H (the HDR image 308) and decompose the input image into a stack (exposure stack 305) of N LDR images at multiple exposures Sᵢ∈ [symbol] with exposure eᵢ∈ [symbol] and gamma correction γ. This can be expressed as follows.

$$S = \{ {S}_{i} = {( H * {2}^{{e}_{i}} )}^{γ} \vert i ∈ \{ 1 , 2 , … , N \} \} \qquad ( 1 )$$

The exposure stack 305 is provided to a weight generator 310. The weight generator 310 can be part of an AI tone mapping model 304, which can be the AI tone mapping model 204. The weight generator 310 generates from the exposure stack 305 a weight stack 306. The weight stack 306 acts as a fusion weight map to perform image fusion using the weight stack 306 and the exposure stack 305. In various embodiments, the weight generator 310 can be a deep machine learning model such as a deep convolutional neural network. The weight generator 310 (G: [symbol] → [symbol] ) maps the exposure stack 305 (S) into the stack of weight maps 306, which are fused into the final output, Sₒᵤₜ=F(G(S), S), to learn fusion weights.

In various embodiments, the network of the weight generator 310 can be a U-Net model. In various embodiments, the inputs to the weight generator 310 can be of dimension (H, W, C*F), where H and W are the image height and width, C is the color channels (3), and F is the number of frames. A series of convolutional blocks (which can include convolutional layers, batch normalization, and rectified linear unit (ReLU) activation functions) first process the input into an image stack with 64 channels. The image can then pass through a series of downsampling blocks (which can include maxpool operations, convolutional layers, batch normalization, and ReLU). In each block, the resulting image dimensions are halved while the number of channels is doubled. After downsampling, the image passes through a series of upsampling blocks (which can include bilinear upsampling, convolutional layers, batch normalization, and ReLU). In each block, the resulting image dimensions are doubled while the number of channels is halved. A sigmoid function can then be applied to the output. The resulting image, which represents a fusion weight map, possesses dimensions (H, W, F).

The weight stack 306 and the exposure stack 305 are provided to an image fusion operation 302, which can be the LDR image creation operation 202. The image fusion operation 302 generates a fused LDR image 309 based on the exposure stack 305 and the corresponding weight stack 306. In general, the image fusion operation 302 combine portions of images from the exposure stack 305 based on the weight stack 306. For example, the image fusion operation 302 can take parts of the images, such as a region of the image having higher quality, and replace that region with the higher quality region, while getting rid of regions having lower quality, such as dark regions having less visual detail. In various embodiments, the image fusion operation 302 can be performed by decomposing the images into a Laplacian pyramid, performing a weighted sum of the Laplacian pyramids, and reforming the final image from the resulting pyramid.

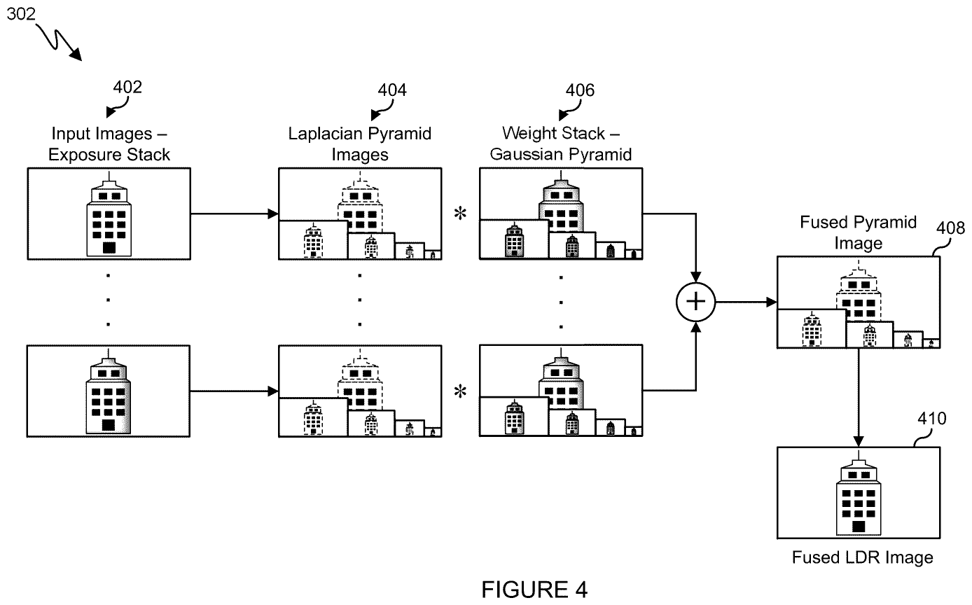

For instance, FIG. 4 illustrates an example image fusion operation 302 in accordance with this disclosure. For ease of explanation, the operation 302 shown in FIG. 4 may be described as being implemented on or supported by the electronic device 101 in the network configuration 100 of FIG. 1. However, the operation 302 shown in FIG. 4 could be used with any other suitable device(s) and in any other suitable system(s), such as when the operation 302 is implemented on or supported by the server 106.

As shown in FIG. 4, input images 402, such as the exposure stack 305, are decomposed into Laplacian pyramid images 404. The n-level Laplacian pyramid of an image I can be expressed as follows.

$$\begin{matrix}{I}_{n} = {D}_{2}^{n} ( I ) \\ {I}_{k} = {D}_{2}^{k} ( I ) - {U}_{2}^{1} ( {I}_{k + 1} ) , k ∈ [ 0 , n )\end{matrix} \qquad ( 2 )$$

### Here,

$${D}_{2}^{k} ( \cdot ) and {U}_{2}^{k} ( \cdot )$$

are the downsample and upsample operators by a factor of 2^{k}.

The Laplacian pyramids are weighted by the n-level gaussian pyramid of the weight map in the weight stack 406 (where the i-th level corresponds to the input, downsampled by 2ⁱ), and combined or fused into a fused pyramid image 408, which is then converted into a fused LDR image 410, which can be the fused LDR image 309 of FIG. 3.

As further shown in FIG. 3, during training, the losses are obtained based on the HDR image 308 and the fused LDR image 309. These losses can include image quality (IQ) losses, structural losses, and adversarial losses, which are combined to optimize the machine learning system. As shown in FIG. 3, the losses are backpropagated through the system to optimize at least the weight generator 310 and the synthesis of the exposure stack based on the exposure scaling and gamma. The image quality loss is used to augment the adversarial and structural loss, which leads to an overall loss (L) that is a combination of generator loss (L_{G}) and IQ loss (L_{IQ}), which can be expressed as follows.

$$L = {L}_{G} + {L}_{IQ} = {λ}_{struct} {L}_{struct} + {λ}_{adv} {L}_{adv} - {λ}_{WE} {L}_{WE} - {λ}_{S} {L}_{S} - {λ}_{C} {L}_{C} \qquad ( 3 )$$

Here, a larger λ encourages penalizing the corresponding loss more and vice versa. The λs are determined experimentally.

The overall loss (L) described above can be dissected as follows. The deep tone mapping operator is trained by a generator loss L_{G}, which can be expressed as follows.

$${L}_{G} = {λ}_{struct} {L}_{structf} + {λ}_{adv} {L}_{adv} \qquad ( 4 )$$

L_{struct} is used to ensure the tone mapped output shares structural similarities with the input, which can be expressed as follows.

$${L}_{struct} = {\sum }_{k} ρ ( {Y}_{K} , G ( {Y}_{K} ) ) , ρ ( I , J ) = \frac{1}{N} {\sum }_{{P}_{I} , {P}_{J}} \frac{cov ( {P}_{I} , {P}_{J} )}{σ ( {P}_{I} ) σ ( {P}_{J} )} \qquad ( 5 )$$

This can include calculating a Pearson correlation for all 5×5 image patches P_{I} at multiple spatial scales k, between network generalized input HDR image 308 Y_{K} and output LDR image 309 G(Y_{K}). The spatial scales (which are different from exposure scales) are multiscale image analyses where each spatial scale is obtained by bicubic 2× downsampling from the previous one. L_{adv} is the adversarial loss, which can be expressed as follows.

$${L}_{adv} = {\sum }_{k} {{𝔼}_{Y ∼ HDR} [ {D}_{k} ( {G ( y )}_{k} - 1 ]}^{2} \qquad ( 6 )$$

In various embodiments, the network is trained by an unsupervised loss that does not require any training data and can be calculated directly from the output LDR image 309. However, a training set can still be used to make the network more generalizable. The loss term can include three terms, and each loss term is maximized. Since the overall loss is minimized, the terms are multiplied by negative 1 as shown below. Three hyperparameters (λ) tune the weight of each loss. The images are size M×N with C color channels. For example, let Sᵢⱼₖ denote the pixel value of LDR image 309 at row i, column j and color k. Then:

$${L}_{IQ} = - {λ}_{WE} {L}_{WE} - {λ}_{S} {L}_{S} - {λ}_{C} {L}_{C} \qquad ( 7 )$$

Here, WE is well-exposedness of the image, S is saturation of the image, and C is contrast of the image.

Well-exposedness can be expressed as follows.

$${L}_{WE} = \frac{1}{MN} {\sum }_{ij}^{i = M , j = N} {Π}_{k}^{c} exp ( \frac{{( {s}_{ijk} - 0.5 )}^{2}}{2 {σ}^{2}} ) \qquad ( 8 )$$

Here, σ is a hyperparameter that penalizes very large or small luma values, i.e., very dark or bright pixels. A large σ penalizes less on extreme pixel values, while a small σ penalizes more.

Saturation can be expressed as follows.

$${L}_{S} = \frac{1}{MNC} {\sum }_{ijk}^{i = M , j = N , k = C} {( {S}_{ijk} - {μ}_{ij} )}^{2} ; {μ}_{ij} = \frac{1}{c} {\sum }_{k}^{k = C} {S}_{ijk} \qquad ( 9 )$$

Contrast can be expressed as follows.

$${L}_{c} = y ⊙ ∇ \qquad ( 10 )$$

Here, Y=luma(S),

$$∇ = [ \begin{matrix}0 & 1 & 0 \\ 1 & - 4 & 1 \\ 0 & 1 & 0\end{matrix} ] ,$$

which is the discrete Laplacian, and [symbol] is the convolution operator.

The training of the network in this way assists with learning good tone mapping function to improve overall image quality and reduce or eliminate image artifacts such as lighting artifacts. The training also assists with maintaining scenes in images without hallucinating another image of a different scene.

As also shown in FIG. 3, a discriminator network 312 can be used to test the LDR image 309 output by the process 300. This separate discriminator network 312 is trained with a discriminator loss, which can be expressed as follows.

$${L}_{D} = {\sum }_{k} {{𝔼}_{Y ∼ HDR} [ {D}_{k} ( {G ( y )}_{k} ) ]}^{2} + {{𝔼}_{X ∼ LDR} [ {D}_{k} ( {X}_{k} ) - 1 ]}^{2} \qquad ( 11 )$$

Here, the subscript k denotes the spatial scale at which the loss is calculated. X denotes a real LDR image from the LDR dataset 307. Y denotes the HDR image 308. G is the generator network, while D is the discriminator network. Note that unlike the generator, there can be multiple discriminators trained for different spatial scale k. That is, discriminator predictions can performed for multiscale image representation, indicated by the subscript k.

In various embodiments, the discriminator network 312 can be a sequential convolution and fully-connected neural network which outputs a binary decision on whether its input is a real LDR image (from LDR dataset) or a fake LDR image (generated by the generator). That is, the discriminator network 312 is trained to attempt to predict “real” (or a value of 1) for images coming from an LDR image dataset 307, and to predict “fake” (or a value of 0) for images output by the AI tone mapping network, such as the fused LDR image 309. The discriminator 312 can thus be used to reinforce training of the AI tone mapping network with the goal being that during the course of training, the outputs of the AI tone mapping network become indistinguishable to the discriminator network 312 from the images in the LDR dataset 307.

Although FIG. 3 illustrates one example of an AI tone mapping process 300 using a weight generator and image fusion, various changes may be made to FIG. 3. For example, various components and functions in FIG. 3 may be combined, further subdivided, replicated, or rearranged according to particular needs. Also, one or more additional components and functions may be included if needed or desired.

Although FIG. 4 illustrates one example of image fusion operation 302, various changes may be made to FIG. 4. For example, various components and functions in FIG. 2 may be combined, further subdivided, replicated, or rearranged according to particular needs. Also, one or more additional components and functions may be included if needed or desired. It will also be understood that other types of image fusion techniques could be used to fuse the images of the exposure stack into a single LDR output image.

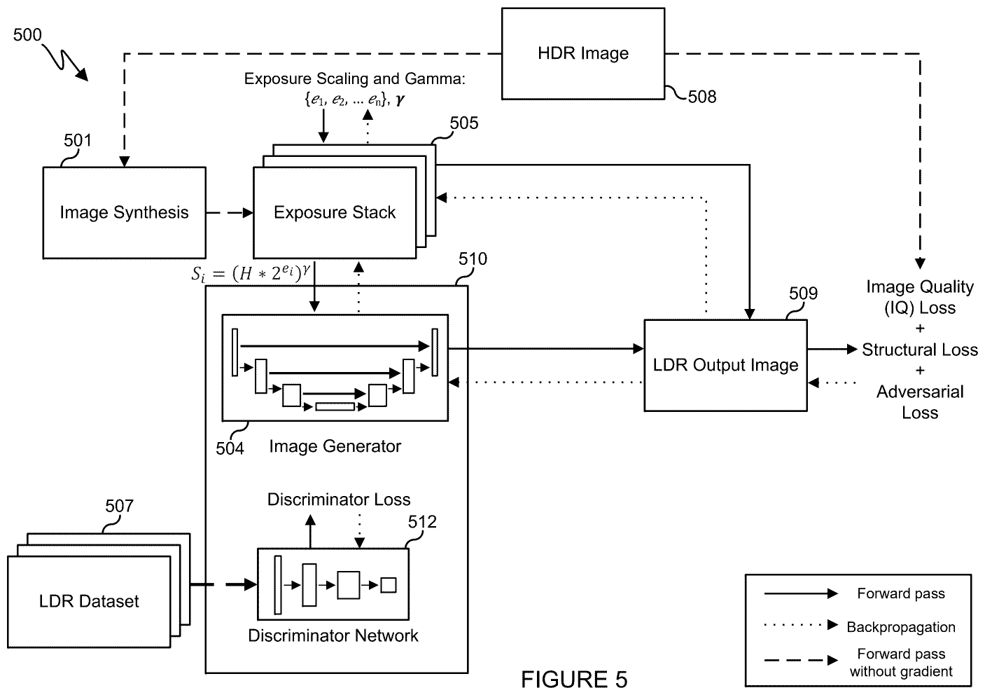

FIG. 5 illustrates an example AI tone mapping process 500 using an LDR image generator in accordance with this disclosure. For ease of explanation, the process 500 shown in FIG. 5 may be described as being implemented on or supported by the electronic device 101 in the network configuration 100 of FIG. 1. However, the process 500 shown in FIG. 5 could be used with any other suitable device(s) and in any other suitable system(s), such as when the process 500 is implemented on or supported by the server 106.

As described with respect to FIG. 3, the process 300 involves using the weight generator 310, e.g., a deep network G: [symbol] → [symbol] , that maps the exposure stack 305 (S) into a stack of weight maps 306, which are fused into a final output, Sₒᵤₜ=F(G(S), S). This approach learns the fusion weight.

As shown in FIG. 5, the process 500 involves using an image generator 510, which can be a deep network G: [symbol] → [symbol] , that maps an exposure stack 505 (S) into a [symbol] tone mapped LDR image 509, Sₒᵤₜ=G(S). This approach directly learns the LDR image.

As shown in FIG. 5, the process 500 includes performing an image synthesis operation 501 on an HDR image 508. The process 500 includes providing the HDR image 508 to an image synthesis operation 501. The image synthesis operation 501 generates an exposure stack 505 (S) based on the HDR image 508 (H) as well as exposure scaling and gamma settings. For example, the operation 501 can take an input image H (the HDR image 508) and decompose the input image into a stack (exposure stack 505) of N LDR images at multiple exposures Sᵢ∈ [symbol] with exposure eᵢ∈ [symbol] and gamma correction γ, such as showin in Equation 1.

The exposure stack 505 is provided to the image generator 510. The image generator 510 can be part of an AI tone mapping model 504, which can be the AI tone mapping model 204. As noted above, the image generator 510 maps the exposure stack 505 into a tone mapped LDR image 509.

In various embodiments, the network of the image generator 510 can be a U-Net model. In various embodiments, the inputs to the image generator 510 can be of dimension (H, W, C*F), where H and W are the image height and width, C is the color channels (3), and F is the number of frames. A series of convolutional blocks (which can include convolutional layers, batch normalization, and ReLU activation functions) first process the input into an image stack with 64 channels. The image can then pass through a series of downsampling blocks (which can include maxpool operations, convolutional layers, batch normalization, and ReLU). In each block, the resulting image dimensions are halved while the number of channels is doubled. After downsampling, the image passes through a series of upsampling blocks (which can include bilinear upsampling, convolutional layers, batch normalization, and ReLU). In each block, the resulting image dimensions are doubled while the number of channels is halved. A sigmoid function can then be applied to the output. The resulting LDR image possesses dimensions (H, W, 3).

As further shown in FIG. 5, during training, losses are obtained based on the HDR image 508 and the LDR output image 509. As described with respect to FIG. 3, these losses can include image quality (IQ) losses, structural losses, and adversarial losses, which are combined to optimize the machine learning system. As shown in FIG. 5, the losses are backpropagated through the system to optimize at least the image generator 510 and the synthesis of the exposure stack based on the exposure scaling and gamma. The image quality loss is used to augment the adversarial and structural loss, which leads to an overall loss (L) that is a combination of generator loss (L_{G}) and IQ loss (L_{IQ}), as shown and described with respect to Equations 3-10.

The training of the network in this way assists with learning good tone mapping function to improve overall image quality and reduce or eliminate image artifacts such as lighting artifacts. The training also assists with maintaining scenes in images without hallucinating another image of a different scene.

As also shown in FIG. 5, a discriminator network 512 can be used to test the LDR image 509 output by the process 500. As also described with respect to FIG. 3, this separate discriminator network 512 is trained with a discriminator loss. In various embodiments, the discriminator network 512 can be a sequential convolution and fully-connected neural network which outputs a binary decision on whether its input is a real LDR image (from LDR dataset) or a fake LDR image (generated by the generator). That is, the discriminator network 512 is trained to attempt to predict “real” (or a value of 1) for images coming from an LDR image dataset 507, and to predict “fake” (or a value of 0) for images output by the AI tone mapping network, such as the LDR image 509. The discriminator 512 can thus be used to reinforce training of the AI tone mapping network with the goal being that during the course of training, the outputs of the AI tone mapping network become indistinguishable to the discriminator network 512 from the images in the LDR dataset 507.

Although FIG. 5 illustrates one example of an AI tone mapping process 500 using an image generator, various changes may be made to FIG. 5. For example, various components and functions in FIG. 5 may be combined, further subdivided, replicated, or rearranged according to particular needs. Also, one or more additional components and functions may be included if needed or desired.

The training procedure for the embodiments of the AI tone mapping network, described with respect to FIGS. 2 through 5, can be divided into blocks, including a section of the overall training sequence in which the learning rate, loss weights, and various hyperparameters are kept constant. These “blocks” are used to organize the training schedule into discrete phases. These blocks can be described as follows.

### Training Blocks:

1. Exposure scaling value (E={e₁, e₂, . . . eₙ}) and gamma (γ) initialization. The initial values of E and γ can either be set by hand, or through an optimization procedure. In the optimization case, the value can be selected by optimizing the IQ metrics/loss for the fused image obtained by non-AI exposure fusion L_{IQ-EF}. In this case, the network weights may not be updated. This can be expressed as follows.

$${E}^{*} = {L}_{IQ - EF} ( E ) \qquad ( 12 )$$

2. Neural network weights G and exposure values E are simultaneously updated to minimize the overall loss L (including image quality, adversarial, structural loss). This can be expressed as follows.

$${G}^{*} , {E}^{*} = arg min G , arg min E L ( G , E ) \qquad ( 13 )$$

3. The exposure scaling value and gamma are frozen, E*, and only the neural network weights G are optimized to minimize the loss. This can be expressed as follows.

$${G}^{*} = arg min G L ( G , {E}^{*} ) \qquad ( 14 )$$

Inference: After training, the network weights are frozen and the adversarial loss is set to zero to prevent gradients from flowing back to exposure value and gamma. At inference time the exposure value and gamma are still optimizable since the IQ losses are dependent only on the output image.

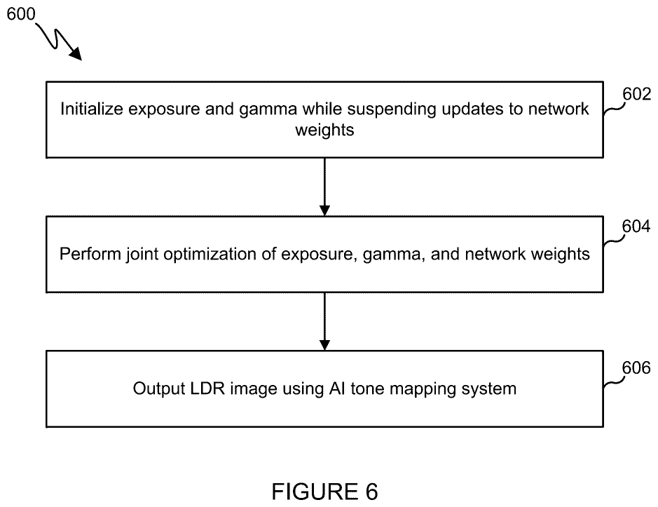

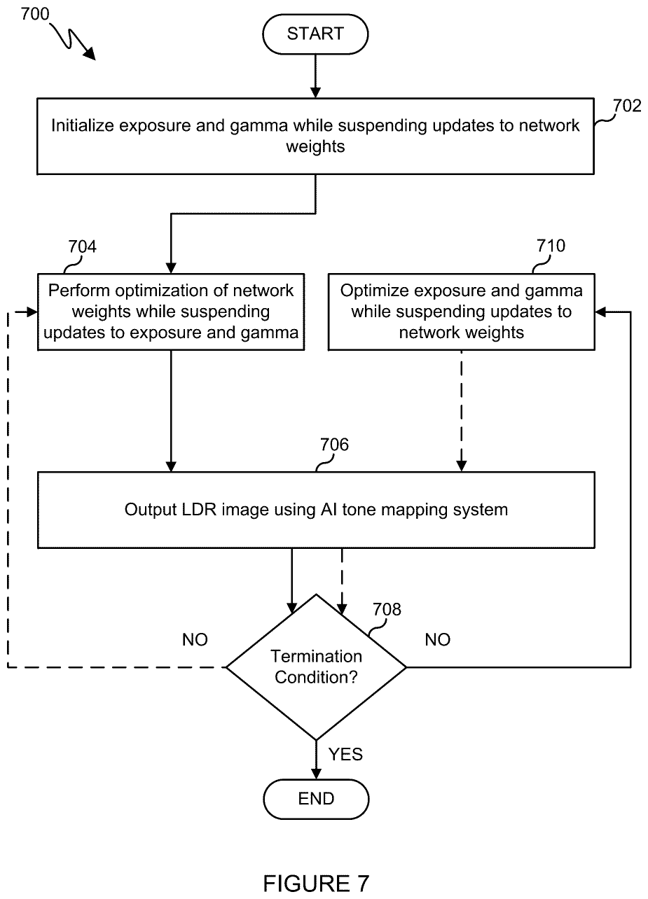

There can be many possible orderings of the training blocks described above. FIGS. 6 and 7 illustrate two possible orderings.

FIG. 6 illustrates an example training control method 600 in accordance with this disclosure. For ease of explanation, the method 600 shown in FIG. 6 may be described as being performed using the electronic device 101 in the network configuration 100 of FIG. 1. However, the method 600 could be performed using any other suitable device(s), such as the server 106, and in any other suitable system(s).

At step 602, exposure and gamma are initialized while updates to the network weights are suspended. At step 604, joint optimization of exposure, gamma, and the network weights is performed. That is, exposure, gamma, and the network weights are simultaneously optimized. At step 606, an LDR image is output using the AI tone mapping system.

Although FIG. 6 illustrates one example training control method 600, various changes may be made to FIG. 6. For example, while shown as a series of steps, various steps in FIG. 6 could overlap, occur in parallel, occur in a different order, or occur any number of times (including zero times).

FIG. 7 illustrates another example training control method 700 in accordance with this disclosure. For ease of explanation, the method 700 shown in FIG. 7 may be described as being performed using the electronic device 101 in the network configuration 100 of FIG. 1. However, the method 700 could be performed using any other suitable device(s), such as the server 106, and in any other suitable system(s).

The method 700 involves an alternating optimization procedure. At step 702, exposure and gamma are initialized while updates to the network weights are suspended. At step 704, optimization of the network weights is performed while suspending updates to exposure and gamma. At step 706, an LDR image is output using the AI tone mapping system based on the current state of the AI tone mapping system. The method 700 then alternates this procedure. For example, at step 708, it is determined whether a termination condition is reached, such as if a threshold image quality is achieved. If not, the method 700 moves to step 710, where the exposure and gamma are optimized while updates to the network weights are suspended. The method 700 then moves to step 706 again, where an LDR image is output using the AI tone mapping system based on the current state of the AI tone mapping system. If the termination condition is still not met, the method 700 can then move back to step 704 to again optimize the network weights. As shown in FIG. 7, the method 700, based on step 708, loops to potentially repeatedly perform steps 704, 706, and 710 in an alternating manner until the termination condition is reached and the method 700 ends.

The method 700 thus functions to optimize one of the exposure scaling value and gamma or the network weights alternately. It will be understood that this alternating optimization can be performed iteratively until the termination condition is achieved, and training can then be completed.

Although FIG. 7 illustrates one example training control method 700, various changes may be made to FIG. 7. For example, while shown as a series of steps, various steps in FIG. 7 could overlap, occur in parallel, occur in a different order, or occur any number of times (including zero times). For example, while FIG. 7 shows the network weights being optimized first at step 704, it is also possible that step 710 could be performed after step 702 in order to first optimize the exposure and gamma, and then optimize the network weights on the next iterative alternation.

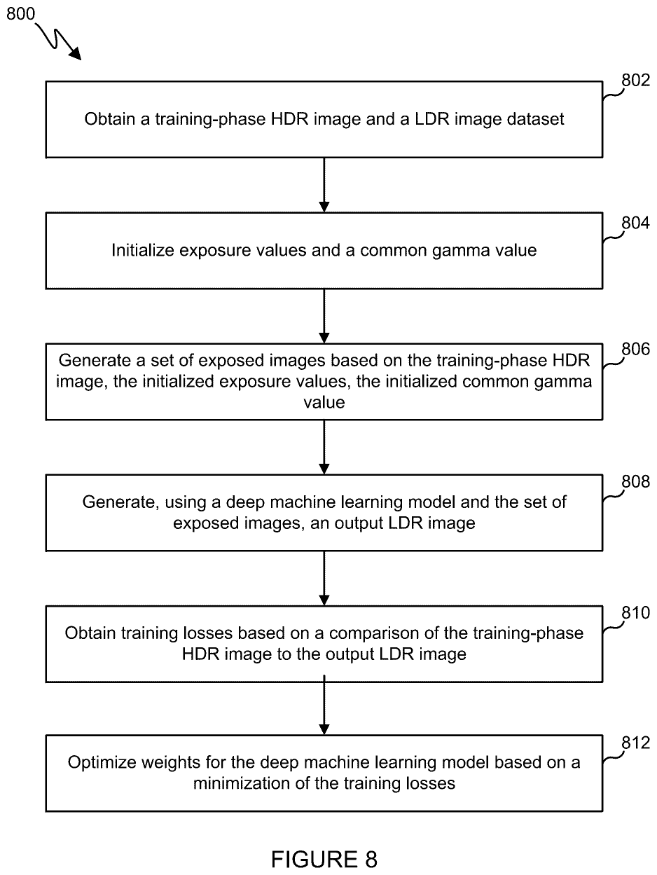

FIG. 8 illustrates an example method 800 for AI tone mapping model training in accordance with this disclosure. For ease of explanation, the method 800 shown in FIG. 8 is described as being performed using the electronic device 101 in the network configuration 100 of FIG. 1. However, the method 800 could be performed using any other suitable device(s), such as the server 106, and in any other suitable system(s).

At step 802, a training-phase HDR image, such as from HDR image dataset 203, and an LDR image dataset, such as the LDR image dataset 207, are obtained for use in training the AI tone mapping model. At step 804, exposure values and a common gamma value are initialized. At step 806, a set of exposed images are generated based on the training-phase HDR image, the initialized exposure values, and the initialized common gamma value. This can include the processor 120 executing the image synthesis operation 301 or 501 to create the set of exposed images, which can be the exposure stack 305 or 505 including a plurality of LDR images at various exposures.

At step 808, an output LDR image is generated using a deep machine learning model and the set of exposed images. In some embodiments, this can include the processor 120 executing the weight generator 310 to generate a set of fusion weight maps using the set of exposed images, such as the exposure stack 305, and executing the image fusion operation 302 to generate a fused LDR image based on the set of exposed images and the set of fusion weight maps. In some embodiments, this can include the processor 120 executing the image generator 510 to map the set of exposed images, such as the exposure stack 505, into an output LDR image.

At step 810, training losses are obtained based on a comparison of the training-phase HDR image to the output LDR image, such as the fused LDR image 309 or the output LDR image 509. This can include the processor 120 determining losses such as structural losses, adversarial losses, and image quality losses to determine an overall losses for use in optimizing the system, such as shown and described with respect to equations 3-10. At step 812, weights for the deep machine learning model are optimized based on a minimization of the training losses. As described in this disclosure, the optimization process can vary depending on desired implementation. For example, step 812 can include the processor 120, using the obtained losses, optimizing the exposure values and the common gamma value simultaneously with the weights for the deep machine learning model based on the minimization of the training losses, such as described with respect to FIG. 6. As another example, step 812 can include the processor 120, using the obtained losses, performing an alternating optimization of the exposure/gamma values and the weights for the deep machine learning model based on the minimization of the training losses, such as described with respect to FIG. 7.

Although FIG. 8 illustrates one example of a method 800 for AI tone mapping model training, various changes may be made to FIG. 8. For example, while shown as a series of steps, various steps in FIG. 8 could overlap, occur in parallel, occur in a different order, or occur any number of times (including zero times). For instance, the method 800 may also include using a discriminator network, such as the discriminator network 312 or 512, trained based on an LDR image dataset to discriminate between LDR images generated using the AI-based image tone mapping model and LDR images from the LDR image dataset.

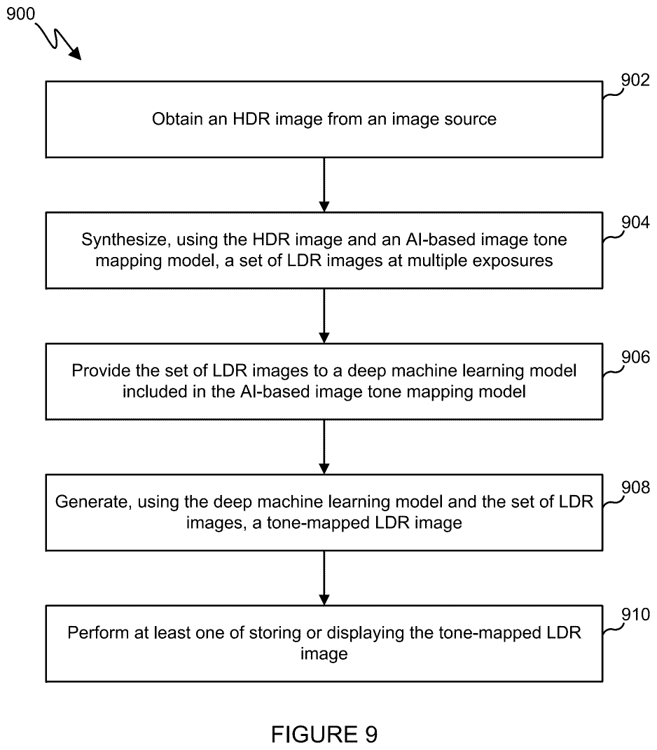

FIG. 9 illustrates an example method 900 for AI tone mapping of an HDR image to an LDR image in accordance with this disclosure. For ease of explanation, the method 900 shown in FIG. 9 is described as being performed using the electronic device 101 in the network configuration 100 of FIG. 1. However, the method 900 could be performed using any other suitable device(s), such as the server 106, and in any other suitable system(s).

At step 902, an HDR image is obtained from an image source. This can include the processor 120 executing an application such as a camera application to capture an image of a scene, or retrieving a stored image from a storage location. Steps 904-908 can be performed by an artificial intelligence (AI)-based image tone mapping model, such as the AI tone mapping model 204, 304, or 504, to process the HDR image. At step 904, a set of LDR images at multiple exposures is synthesized using the HDR image. This can include the processor 120 executing the image synthesis operation 301 or 501. In some embodiments, this can include the processor 120 executing the camera application to take multiple images with different exposure settings, or, in some embodiments, manipulating previously stored images to have different exposures.

At step 906, the set of LDR images are provided to a deep machine learning model included in the AI-based image tone mapping model and, at step 908, a tone-mapped LDR image is generated using the deep machine learning model and the set of LDR images. In some embodiments, this can include the processor 120 executing the weight generator 310 to generate a set of fusion weight maps using the set of exposed images, such as the exposure stack 305, and executing the image fusion operation 302 to generate a fused LDR image based on the set of exposed images and the set of fusion weight maps. As described with respect to FIG. 4, performing image fusion using the set of LDR images and the set of fusion weight maps to generate the fused LDR image can include decomposing the LDR images into Laplacian pyramid images, performing a weighted sum of the Laplacian pyramid images to create a fused pyramid image, and forming the fused LDR image from the fused pyramid image. In some embodiments, steps 906 and 908 can include the processor 120 executing the image generator 510 to map the set of exposed images, such as the exposure stack 505, into an output LDR image.

At step 910, at least one of storing or displaying the tone-mapped LDR image is performed. This can include the processor 120 executing instruction to cause the tone-mapped LDR image to be displayed on a display, such as the display 160, and/or to be stored in memory, such as the memory 130.

Although FIG. 9 illustrates one example of a method 900 for AI tone mapping of an HDR image to an LDR image, various changes may be made to FIG. 9. For example, while shown as a series of steps, various steps in FIG. 9 could overlap, occur in parallel, occur in a different order, or occur any number of times (including zero times).

It should be noted that the functions shown in FIGS. 2 through 9 or described above can be implemented in an electronic device 101, 102, 104, server 106, or other device(s) in any suitable manner. For example, in some embodiments, at least some of the functions shown in FIGS. 2 through 9 or described above can be implemented or supported using one or more software applications or other software instructions that are executed by the processor 120 of the electronic device 101, 102, 104, server 106, or other device(s). In other embodiments, at least some of the functions shown in FIGS. 2 through 9 or described above can be implemented or supported using dedicated hardware components. In general, the functions shown in FIGS. 2 through 9 or described above can be performed using any suitable hardware or any suitable combination of hardware and software/firmware instructions. Also, the functions shown in FIGS. 2 through 9 or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method for tone mapping a high dynamic range (HDR) image to a low dynamic range (LDR) image, comprising:
obtaining an HDR image;
processing the HDR image using an artificial intelligence (AI)-based image tone mapping model, including:
synthesizing, using the HDR image, a set of LDR images at multiple exposures;
providing the set of LDR images to a deep machine learning model included in the AI-based image tone mapping model; and
generating, using the deep machine learning model and the set of LDR images, a tone-mapped LDR image; and
performing at least one of storing or displaying the tone-mapped LDR image.

2. The method of claim 1, wherein generating, using the deep machine learning model and the set of LDR images, the tone-mapped LDR image includes:
generating, using the deep machine learning model and the set of LDR images, a set of fusion weight maps; and
performing image fusion using the set of LDR images and the set of fusion weight maps to generate a fused LDR image, wherein the fused LDR image is the tone-mapped LDR image.

3. The method of claim 2, performing image fusion using the set of LDR images and the set of fusion weight maps to generate the fused LDR image includes:
decomposing the LDR images into Laplacian pyramid images;
performing a weighted sum of the Laplacian pyramid images to create a fused pyramid image; and
forming the fused LDR image from the fused pyramid image.

4. The method of claim 1, wherein the AI-based image tone mapping model is trained by:
obtaining a training-phase HDR image and an LDR image dataset;
initializing exposure values and a common gamma value;
generating a set of exposed images based on the training-phase HDR image, the initialized exposure values, and the initialized common gamma value;
generating a set of fusion weight maps using the deep machine learning model and the set of exposed images;
generating a fused LDR image based on the set of exposed images and the set of fusion weight maps;
obtaining training losses based on a comparison of the training-phase HDR image to the fused LDR image; and
optimizing weights for the deep machine learning model based on a minimization of the training losses.

5. The method of claim 4, further comprising optimizing the exposure values and the common gamma value simultaneously with the weights for the deep machine learning model based on the minimization of the training losses.

6. The method of claim 4, wherein the training losses comprise:
structural losses;
adversarial losses; and
image quality losses.

7. The method of claim 1, further comprising:
discriminating, using a discriminator network trained based on an LDR image dataset, between LDR images generated using the AI-based image tone mapping model and LDR images from the LDR image dataset.

8. The method of claim 1, wherein the AI-based image tone mapping model is trained by:
obtaining a training-phase HDR image and an LDR image dataset;
initializing exposure values and a common gamma value;
generating a set of exposed images based on the training-phase HDR image, the initialized exposure values, the initialized common gamma value;
mapping, using the deep machine learning model, the set of exposed images into an output LDR image based on the set of exposed images;
obtaining training losses based on a comparison of the training-phase HDR image to the output LDR image; and
optimizing weights for the deep machine learning model based on a minimization of the training losses.

9. An electronic device comprising:
at least one processing device configured to:
obtain an HDR image;
process the HDR image using an artificial intelligence (AI)-based image tone mapping model, wherein the at least one processing device is further configured to:
synthesize, using the HDR image, a set of LDR images at multiple exposures;
provide the set of LDR images to a deep machine learning model included in the AI-based image tone mapping model; and
generate, using the deep machine learning model and the set of LDR images, a tone-mapped LDR image; and
perform at least one of storing or displaying the tone-mapped LDR image.

10. The electronic device of claim 9, wherein, to generate, using the deep machine learning model and the set of LDR images, the tone-mapped LDR image, the at least one processing device is further configured to:
generate, using the deep machine learning model and the set of LDR images, a set of fusion weight maps; and
perform image fusion using the set of LDR images and the set of fusion weight maps to generate a fused LDR image, wherein the fused LDR image is the tone-mapped LDR image.

11. The electronic device of claim 10, wherein, to perform image fusion using the set of LDR images and the set of fusion weight maps to generate the fused LDR image, the at least one processing device is further configured to:
decompose the LDR images into Laplacian pyramid images;
perform a weighted sum of the Laplacian pyramid images to create a fused pyramid image; and
form the fused LDR image from the fused pyramid image.

12. The electronic device of claim 9, wherein, to train the AI-based image tone mapping model, the at least one processing device is configured to:
obtain a training-phase HDR image and an LDR image dataset;
initialize exposure values and a common gamma value;
generate a set of exposed images based on the training-phase HDR image, the initialized exposure values, and the initialized common gamma value;
generate a set of fusion weight maps using the deep machine learning model and the set of exposed images;
generate a fused LDR image based on the set of exposed images and the set of fusion weight maps;
obtain training losses based on a comparison of the training-phase HDR image to the fused LDR image; and
optimize weights for the deep machine learning model based on a minimization of the training losses.

13. The electronic device of claim 12, wherein, to train the AI-based image tone mapping model, the at least one processing device is further configured to optimize the exposure values and the common gamma value simultaneously with the weights for the deep machine learning model based on the minimization of the training losses.

14. The electronic device of claim 12, wherein the training losses comprise:
structural losses;
adversarial losses; and
image quality losses.

15. The method of claim 1, wherein the at least one processing device is further configured to:
discriminate, using a discriminator network trained based on an LDR image dataset, between LDR images generated using the AI-based image tone mapping model and LDR images from the LDR image dataset.

16. The electronic device of claim 9, wherein, to train the AI-based image tone mapping model, the at least one processing device is configured to:
obtain a training-phase HDR image and an LDR image dataset;
initialize exposure values and a common gamma value;
generate a set of exposed images based on the training-phase HDR image, the initialized exposure values, the initialized common gamma value;
map, using the deep machine learning model, the set of exposed images into an output LDR image based on the set of exposed images;
obtain training losses based on a comparison of the training-phase HDR image to the output LDR image; and
optimize weights for the deep machine learning model based on a minimization of the training losses.

17. A non-transitory machine readable medium comprising instructions that when executed cause at least one processor of an electronic device to:
obtain an HDR image;
process the HDR image using an artificial intelligence (AI)-based image tone mapping model, including:
synthesize, using the HDR image, a set of LDR images at multiple exposures;
provide the set of LDR images to a deep machine learning model included in the AI-based image tone mapping model; and
generate, using the deep machine learning model and the set of LDR images, a tone-mapped LDR image; and
perform at least one of storing or displaying the tone-mapped LDR image.

18. The non-transitory machine readable medium of claim 17, wherein the instructions that cause the electronic device to generate, using the deep machine learning model and the set of LDR images, the tone-mapped LDR image, further comprise instructions that when executed cause the at least one processor of the electronic device to:
generate, using the deep machine learning model and the set of LDR images, a set of fusion weight maps; and
perform image fusion using the set of LDR images and the set of fusion weight maps to generate a fused LDR image, wherein the fused LDR image is the tone-mapped LDR image.

19. The non-transitory machine readable medium of claim 17, further comprising instructions to train the AI-based image tone mapping model that when executed cause the at least one processor of the electronic device to:
obtain a training-phase HDR image and an LDR image dataset;
initialize exposure values and a common gamma value;
generate a set of exposed images based on the training-phase HDR image, the initialized exposure values, and the initialized common gamma value;
generate a set of fusion weight maps using the deep machine learning model and the set of exposed images;
generate a fused LDR image based on the set of exposed images and the set of fusion weight maps;
obtain training losses based on a comparison of the training-phase HDR image to the fused LDR image; and
optimize weights for the deep machine learning model based on a minimization of the training losses.

20. The non-transitory machine readable medium of claim 17, further comprising instructions to train the AI-based image tone mapping model that when executed cause the at least one processor of the electronic device to:
obtain a training-phase HDR image and an LDR image dataset;
initialize exposure values and a common gamma value;
generate a set of exposed images based on the training-phase HDR image, the initialized exposure values, the initialized common gamma value;
map, using the deep machine learning model, the set of exposed images into an output LDR image based on the set of exposed images;
obtain training losses based on a comparison of the training-phase HDR image to the output LDR image; and
optimize weights for the deep machine learning model based on a minimization of the training losses.
